(19) United States
(12) Patent Application Publication
(10) Pub. No.: US 2004/0125936 A1
(43) Pub. Date: Jul. 1, 2004

(54) Method and apparatus to optimize bandwidth for compressed voice data

(76) Inventors: Eric P Flynn, Tulla (IE); John M Twomey, Limerick (IE)

Correspondence Address: KENYON & KENYON (SAN JOSE), 333 WEST SAN CARLOS ST., SUITE 600, SAN JOSE, CA, 95110, US

(21) Appl. No.: 10/330,614

(22) Filed: Dec. 26, 2002

(51) Int. Cl. H04M 7/00

(52) U.S. Cl. 379/229

(57) ABSTRACT

A method and apparatus for providing a network signaling method. More particularly, the present invention relates to providing basic POTS (Plain Old Telephone System) telephony between a Customer Premise Equipment (CPE) device and a Central Office (CO) device. The present invention also optimizes bandwidth of voice samples over AAL2 while supporting voice compression.

### BACKGROUND OF THE INVENTION

The present invention relates to a network signaling method and more particularly a method for providing basic POTS (Plain Old Telephone System) telephony between a Customer Premise Equipment (hereinafter, “CPE”) device and a Central Office (hereinafter, “CO”) device.

As known in the art, Asynchronous Transfer Mode (hereinafter, “ATM,” standardized by the specification of the ATM Forum since its inception in 1991) is a multi-service, high speed, scalable technology. It is a dominant switching protocol in carrier backbones, supporting services with different transfer characteristics. ATM simultaneously transports voice, data, graphics and video at very high speeds. ATM is known for easy integration with other technologies and its management features that allow carriers to guarantee Quality of Service (QoS).

Sometimes referred to as cell relay, ATM uses short, fixed-length packets called cells for transport. Information is divided among these cells, transmitted and then re-assembled at their final destination. Fragmentation is built into ATM, with its small, fixed-size, 53-byte cells. Very fast ATM switches speed data through the ATM network. The high bandwidth associated with ATM reduces congestion problems, providing a highly reliable service.

ATM prioritization is implemented through QoS parameters. ATM was designed from the outset to carry voice as well as all types of data. ATM Adaptation Layer 1 (hereinafter, “AAL1,” as specified in International Telecommunication Union—Telecommunication Standardization Sector recommendation 1.363.1, August 1996) protocol in ATM's Constant Bit Rate service (hereinafter, “CBR”, from the ATM Forum specification, AF-TM-0056.000, Approved Traffic Management Specifications, April 1996) was the de facto standard for Voice over ATM (hereinafter, “VoA”). However, this protocol proved inefficient for voice applications. CBR, the highest quality class of ATM service, provides Circuit Emulation Service (CES), which transmits a continuous bit stream of information. This allocates a constant amount of bandwidth to a connection for the duration of a transmission. Although it guarantees high quality voice transmission, CES monopolizes bandwidth that could be used for other applications. In addition, in the interest of reducing delay, CES might send the fixed-size ATM cells half empty rather than waiting the 6 milliseconds for 47 bytes of voice to fill the cell. This wastes over 20 bytes of bandwidth per ATM cell. Dynamic Bandwidth Circuit Emulation Service (DBCES) is a variation of CES. DBCES does not send a constant bit stream of cells, but transmits only when there is an active voice call (off hook). However, like in CES, the cells might remain partially empty. Therefore, using AAL1 for VoA increases the overhead of voice transmissions and wastes bandwidth.

AAL2's Variable Bit Rate (hereinafter, “VBR”) service, as specified in ITU-T recommendation 1.363.2 (International Telecommunication Union—Telecommunication Standardization Sector recommendation 1.363.2, November 2000), allows for the packing of short packets (1 to 45/64 bytes), also called minicells, into one or more ATM cells. This resembles variable sized fragments in other protocols, such as Frame Relay (as specified in the Frame Relay Forum's approved implementation agreements) and IP (Internet Protocol). In contrast to AAL1, which has a fixed payload, AAL2 enables a variable payload within cells. This functionality provides a dramatic improvement in bandwidth efficiency over structured or unstructured circuit emulation using AAL1.

In absence of the VBR function as specified in ITU-T 1.363.2 specification, each ATM cell is only capable of carrying voice samples for one AAL2 channel. However, within ITU-T recommendation 1.366.2 (International Telecommunication Union—Telecommunication Standardization Sector recommendation 1.366.2, November 2000), the specification conveys narrowband telephony calls (including voice-band data) with support for compressed encoding algorithms and silence removal. It also provides special facilities to carry in-band tones, dialed digits, and circuit mode data. As such, compressed voice samples for multiple POTS lines can be carried within the one channel in an attempt to make efficient use of WAN (wide area network) bandwidth.

Large enterprises are increasingly connecting headquarters and main offices to WAN via broadband links such as ATM to accommodate their vast amounts of voice and data transmissions, such as heavy graphics, payroll information and voice and video conferencing. As the telecommunications world moves toward broadband packet-based public networks, next generation services are needed. Currently, new and upcoming services such as Voice over Broadband (hereinafter, “VoBB”) require new technology, and the equipment to support it.

Initially, VoBB was intended simply to provide local dial tone, and was implemented by provisioning a permanent virtual circuit (PVC) between an integrated access device (IAD) and a voice gateway, in turn connecting to a Class 5 switch. The ATM Forum introduced specification AF-VMOA-0145.000 (Voice and Media over ATM-Loop Emulation Service using AAL2, July 2000) with a description of procedures and signaling required to support the efficient transport of voice-band services across an ATM network between two Inter-working Functions (IWF) located respectively at a customer premises and at a service provider premises. It specifies the use of ATM virtual circuits with AAL2 to transport bearer information and signaling. The specification supports the transport of common channel signaling (CCS) information as well as channel associated signaling (CAS) information.

The ATM Forum's Loop Emulation Service using AAL2 specification further describes a transport mechanism to carry voice, voice-band data, fax traffic, and other narrowband services over a broadband subscriber line connection such as xDSL (Digital Subscriber Line), HFC (Hybrid Fiber/Coaxial) or wireless between customer premises and a Service Node such as provided by the public switched telephone network (hereinafter, “PSTN”).

As VoBB continues to evolve, vendors and carriers alike will need the technology to extend its reach to provide connectivity not only to local switches, but also to long distance voice switches and private branch exchanges (PBXs) at networked corporate sites as well. Because VoBB is independent of the actual telephones, as well as the Class 5 and 4 switches in the network, they can carry multiple phone lines over a single pipe, thereby reducing costs in delivering integrated data and voice.

In view of the above, there is a need for a method and apparatus for enabling POTS telephony functionality over AAL2 on a digital signal processing platform using CCS or CAS. Moreover, in the absence of AAL's Variable Bit Rate function as specified in ITU-T 1.363.2 (established within the specification as a CPS SAR function—or Common Part Sublayer and Segmentation and Reassembly), a specific need exists for optimizing bandwidth of voice samples over AAL2 that supports voice compression.

### BRIEF DESCRIPTION OF THE DRAWINGS

FIG. 1a is a diagram of the ATM cell format of an individual CCS message employing an embodiment of the present invention.

FIG. 1b is a diagram of the format of the AAL2 header from a CCS message employing an embodiment of the present invention.

FIG. 1c is a diagram of the format of the voice-band information from a CCS message employing an embodiment of the present invention.

FIG. 2a is a diagram of the Information Element (hereinafter, “IE”) format in a CCS message employing an embodiment of the present invention.

FIG. 2b is a diagram of the format of the POTS Line information element in a CCS message employing an embodiment of the present invention.

FIG. 2c is a diagram of the format of the Channel ID information element in a CCS message employing an embodiment of the present invention.

FIG. 2d is a diagram of the format of the POTS Event information element in a CCS message employing an embodiment of the present invention.

FIG. 2e is a diagram of the format of the Encoding information element in a CCS message employing an embodiment of the present invention.

FIG. 2f is a diagram of the format of the Cause information element in a CCS message employing an embodiment of the present invention.

FIG. 2g is a table of control message types supported and their associated IEs used in a CCS message employing an embodiment of the present invention.

FIG. 3 is a diagram showing an overview of the relationship between the state machines employing an embodiment of the present invention.

FIG. 4 is a state machine diagram showing a CCS protocol operating on each POTS line on the CPE and CO employing an embodiment of the present invention.

FIG. 5 is a state machine diagram showing a CCS protocol for the call control indexed by the CO POTS line number employing an embodiment of the present invention.

FIG. 6 is a flow diagram of a voice call being activated between a CPE device and a CO device employing an embodiment of the present invention.

FIG. 7 is a block diagram showing an equipment setup required to utilize the IPX22x Voice over AAL2 application without employing an embodiment of the present invention.

FIG. 8 is a block diagram showing the equipment setup utilized for IPX22x Voice over AAL2 application when employing an embodiment of the present invention.

FIG. 9 is a diagram of the ATM cell format of compressed voice samples of multiple POTS lines carried within one channel employing an embodiment of the present invention.

FIG. 10 is a diagram of an ATM stream with three sequential calls employing an embodiment of the present invention, and includes a table of the data reflected within these calls in the call control signaling stack.

FIG. 11 is a diagram of an ATM stream with the second call of three sequential calls dropped without utilizing an embodiment of the present invention, and includes a table of the data reflected within these calls in the call control signaling stack.

FIG. 12 is a diagram of an ATM stream with the second call of three sequential calls dropped employing an embodiment of the present invention, and includes a table of the data reflected within these calls in the call control signaling stack.

### DETAILED DESCRIPTION OF THE DRAWINGS

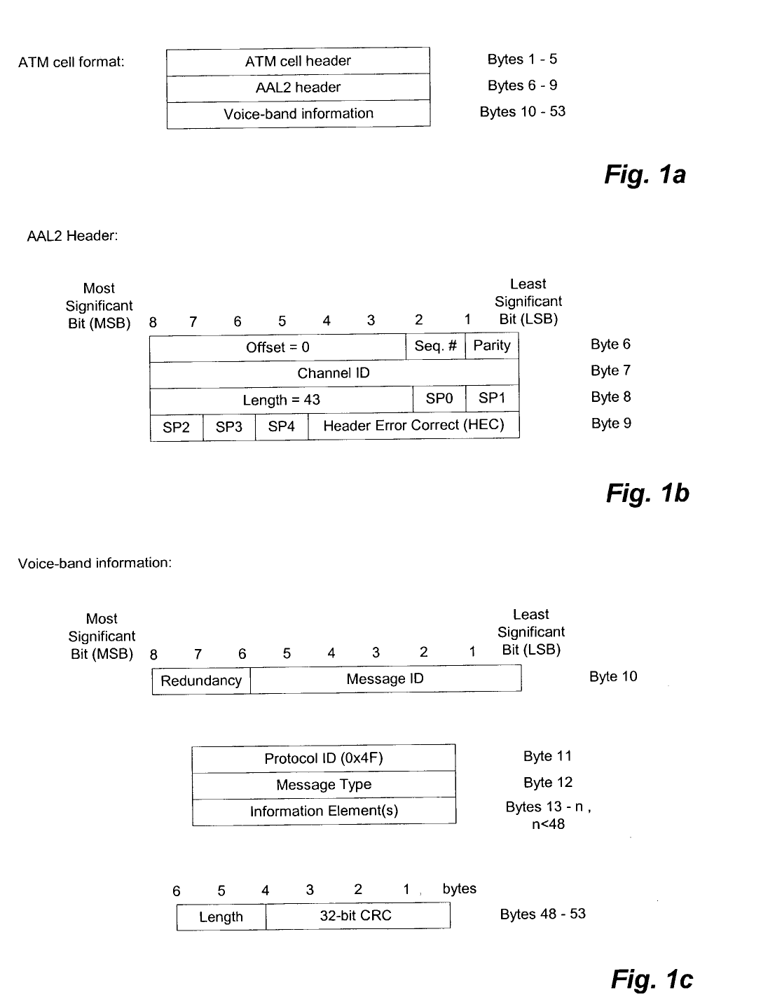

Referring to FIG. 1a, a diagram of the ATM cell format of an individual CCS message employing an embodiment of the present invention is shown. Individual CCS messages do not exceed the size of a single ATM cell. The messages take the format as shown in FIG. 1a. Bytes 1 to 5 contain the ATM cell header, and bytes 6 to 9 contain the AAL2 header. The remaining bytes 10-53 containing the voice-band information.

Referring to FIG. 1b, a diagram of the format of the AAL2 header from a CCS message employing an embodiment of the present invention is shown. In one embodiment of the invention, the AAL2 header of voice sample cells utilizes a Jetstream® Communications' mechanism based on its CPX (a voices services platform) and IAD (integrated access devices, CPE devices or CO devices) signaling platform. The Jetstream® transportation mechanism makes use of user-to-user interface (hereinafter, “UUI”) bits within the AAL2 header to support compressed voice. The UUI bits are designed within the AAL header to be assigned by users for various purposes. In an embodiment of the invention here, the UUI bits are used as sequential position (SP) indicators of voice samples within the one cell. The sequential position indicator is “1” if used and “0” if unused. Also within the AAL2 header, byte 6 contains the sequence number for the individual message and a parity bit. If a message is lost, it can be resent if the protocol records the sequence number from byte 6. Byte 7 contains the Channel ID of the AAL2 channel carrying the voice samples. Byte 8 contains the length of the voice band information, as well as the first two UUI bits (or sequential position indicators). Byte 9 contains the remaining three UUI bits and the Header Error Correction check (HEC).

Referring to FIG. 1c, a diagram of the format of the voice-band information from a CCS message employing an embodiment of the present invention. The first byte within the voice-band information is used for the purposes of reliable transfer. The first two bits are used for redundancy. Each ATM message is transmitted three times at 10 ms intervals. The redundancy values are within the range of 0 to 2 for these 3 messages. Each control message also has a unique Message ID. This remains the same for redundant transmissions for the same message. Redundant messages received will be discarded if they have already been processed. Bytes 11 to 47 include the Protocol ID in byte 11, the message type in byte 12, and the information elements (IE) that form the control messages from bytes 13 and on. The last six bytes, bytes 48 to 53 in this embodiment of the invention, are used to indicate message length and a 32-bit Cyclic Redundancy Check (CRC). The length is defined as the size from byte 11 to the end of the last IE. The 32-bit CRC is calculated using the polynomial x⁷+x⁴+x³+x+1.

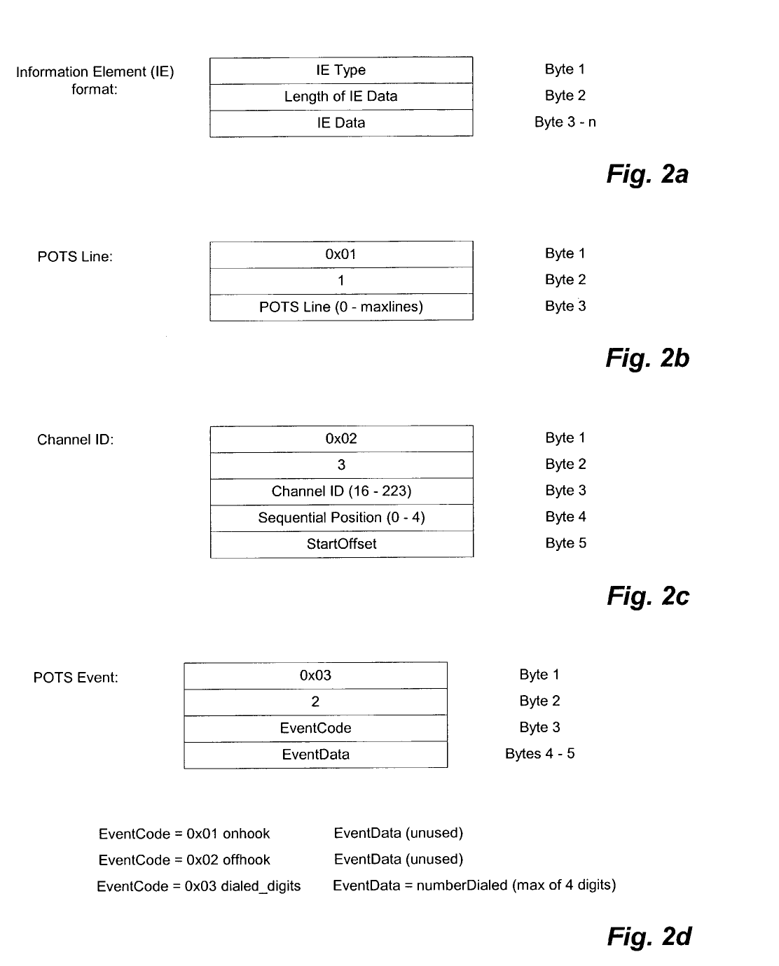

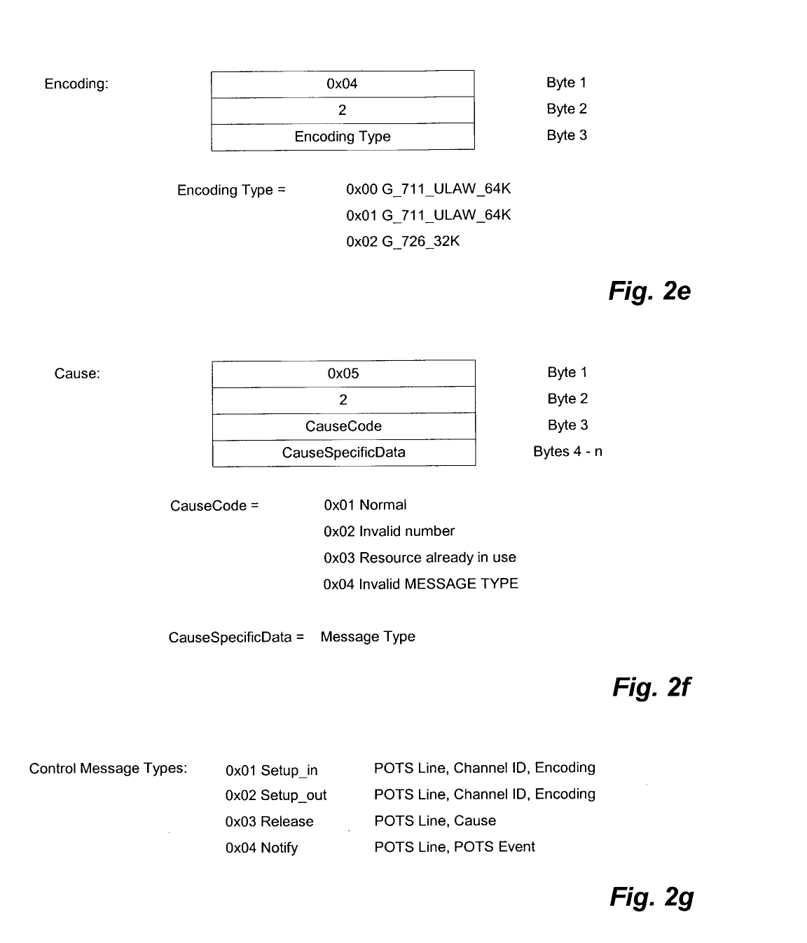

Referring to FIG. 2a, a diagram of the Information Element (IE) format in a CCS message employing an embodiment of the present invention is shown. Byte 1 contains the IE type. Byte 2 contains the length of the IE data, and byte 3 and on contain the IE data itself. FIGS. 2b through 2f show diagrams of the following individual information elements and the data format for them, including POTS Line, Channel ID, POTS Event, Encoding and Cause. These information elements and the variable bytes within the IE form the building block of control and signaling messages for the method described herein. The information elements that can be utilized by this method described herein include those found in FIGS. 2b through 2f, but are not limited to them. Furthermore, the variable bytes given as examples in FIGS. 2d through 2f are not limited to those listed. FIG. 2g includes examples of some of the control message types supported by an embodiment of the present invention and the associated IEs that form these control messages. Other control message types can be found in the ITU-Ts 1.366.2 recommendation and ATM Forum AF-VMOA-0145.000 specification, described above.

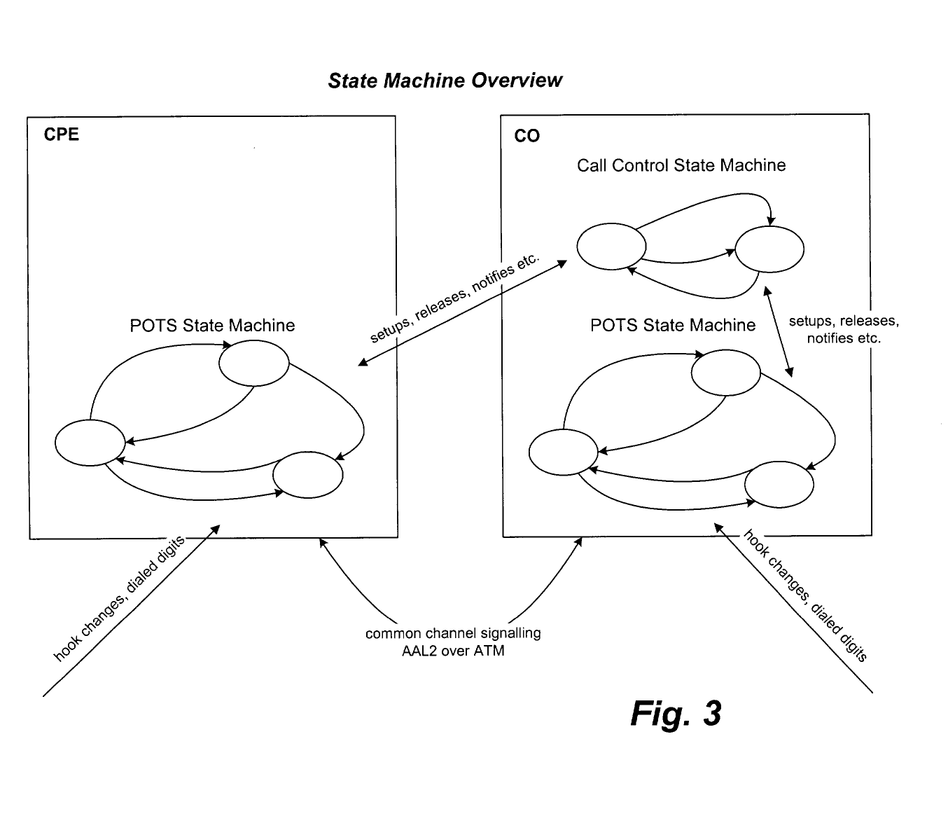

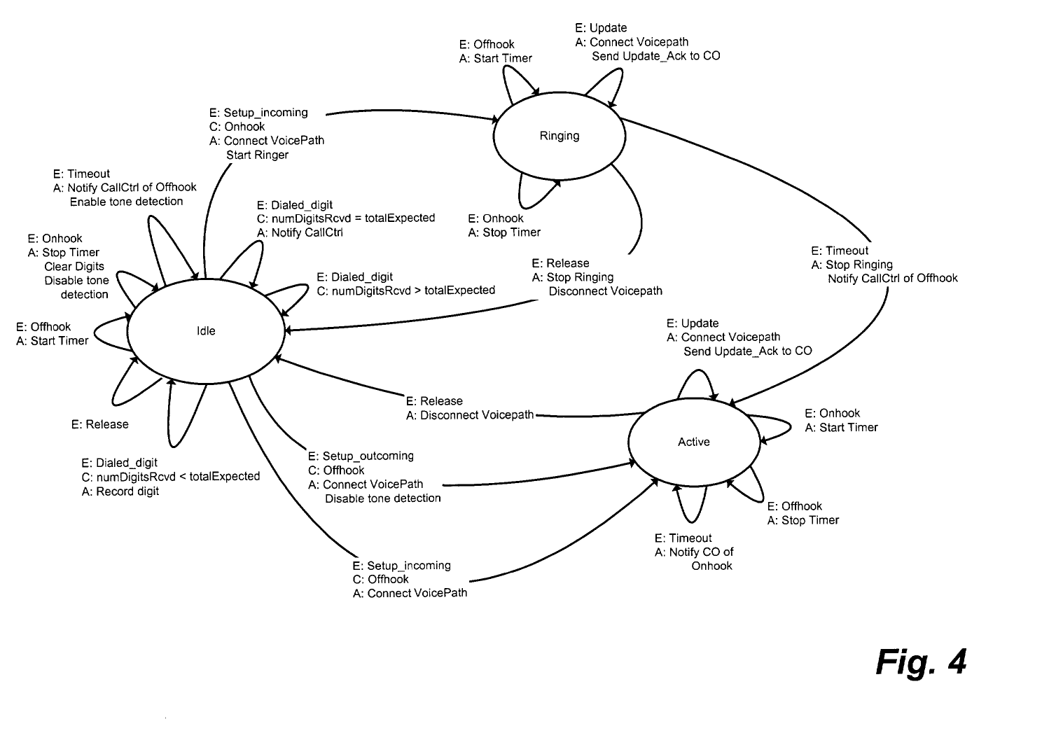

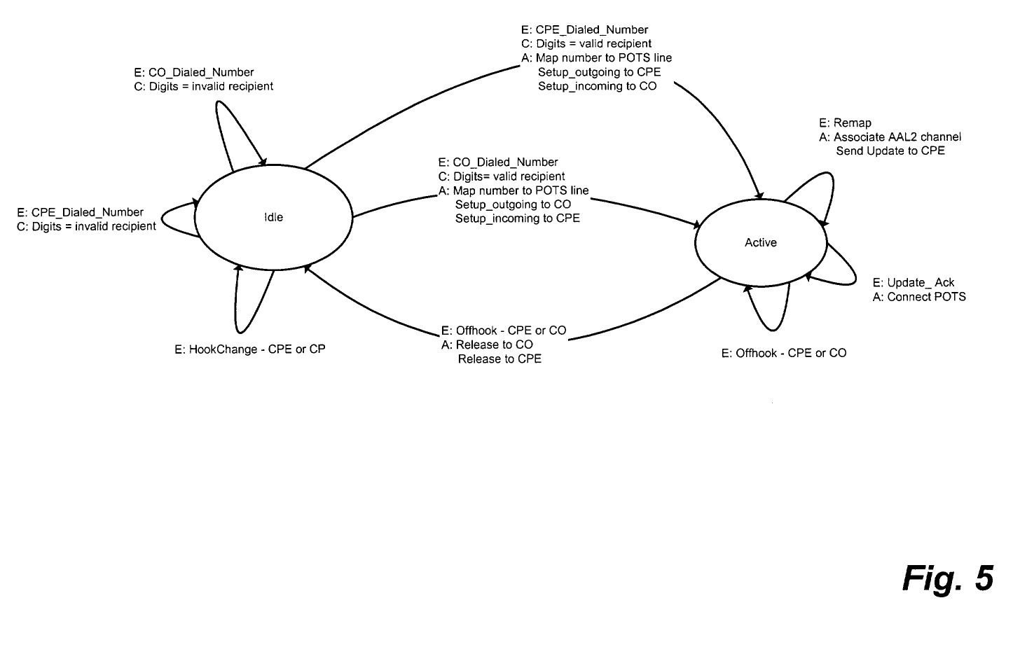

Referring to FIG. 3, a diagram showing an overview of the relationship between the state machines employing an embodiment of the present invention is shown. The components formulating this embodiment of the invention are conceptualized in the relationship between the state machines shown in FIG. 3 and further described in detail in FIG. 4 and FIG. 5. The first component is a POTS state machine, running on the POTS line for each of the CPE and CO devices. The second component is a call control state machine that only runs on the CO device. This call control state machine controls telephony call establishment—simulating voice gateway functionality.

For the POTS state machine, inputs are received in the form of hook changes and dialed digits from the POTS side, and in the form of setup and release messages from the call control side. These hook changes (i.e. the receiver being on hook or off hook) from the CPE and CO POTS state machines drive the call control state machine. These actual events and actions are further described in FIGS. 4 and 5.

Referring to FIG. 4, a state machine diagram showing a CCS protocol operating on each POTS line on the CPE and CO employing an embodiment of the present invention is shown. From the Idle state, the POTS state machine utilizes debounce logic on a hook change. A timer gets started on a reported off hook condition A timeout on the timer causes the action of the hook change, with a notification to the call control state machine of the off hook condition. However, another change of hook state would cancel the timer, remaining at Idle, with no further action taken.

On transition to the Ringing state, start ringer and stop ringer signaling messages are sent to the POTS controller to control the ringer of the POTS device. On leaving the Ringing state, the ringing sequence ceases and a stop ring signaling message gets sent to the POTS controller.

In this embodiment, the state machine also supports DTMF (dual-tone multi-frequency) detection. This allows the receiver of a phone to go off hook at one end and a number of a phone at the other end to be dialed. Each POTS line would be assigned a configurable telephone number. The CO would maintain a directory of these numbers with a mapping to POTS line numbers and their associated integrated access device (IAD) type—either CPE or CO.

When the configured number of dialed digits have been collected in the Idle state following a debounced off hook, the CPE host sends a notify message to the CO state machine with the complete number dialed. This number determines which POTS line will setup the call in Active state.

It should be noted that the events and actions shown in one embodiment of the invention are not inclusive of the events and actions that may be implemented by the present invention.

Referring to FIG. 5, a state machine diagram showing a CCS protocol for the call control indexed by the CO POTS line number employing an embodiment of the present invention is shown. The call control state machine simulates the functionality of a voice gateway.

When the Call Control state machine processes an event that leads to a setup message being sent, the Channel ID (CID), Sequential Position (SP0), and start byte offset within the cell payload are determined. The transmitted setup will contain the CID, SP and offset. Valid CIDs are 16 to 223 in this embodiment. The lowest available CID with sufficient bandwidth is then selected for each call, whether it is a channel already in use or a newly available channel. When the setup is complete and voice-band data is being transferred, the Call Control state machine transfers from Idle state to Active state.

The signaling stack as described herein can be easily adapted to provide other proprietary flavors of VoAAL2 signaling or other standard signaling schemes such as those advocated by in The Broadband Loop Emulation Service (BLES), defined in Annex A of the DSL Forum TR-309 standard, Requirements For Voice Over DSL. Version 1.1, March 2001. The stack, as described in the present invention, forms an effective platform upon which parties can grow new signaling stacks for compressed voice over AAL2 on DSP platforms using VoAAL2.

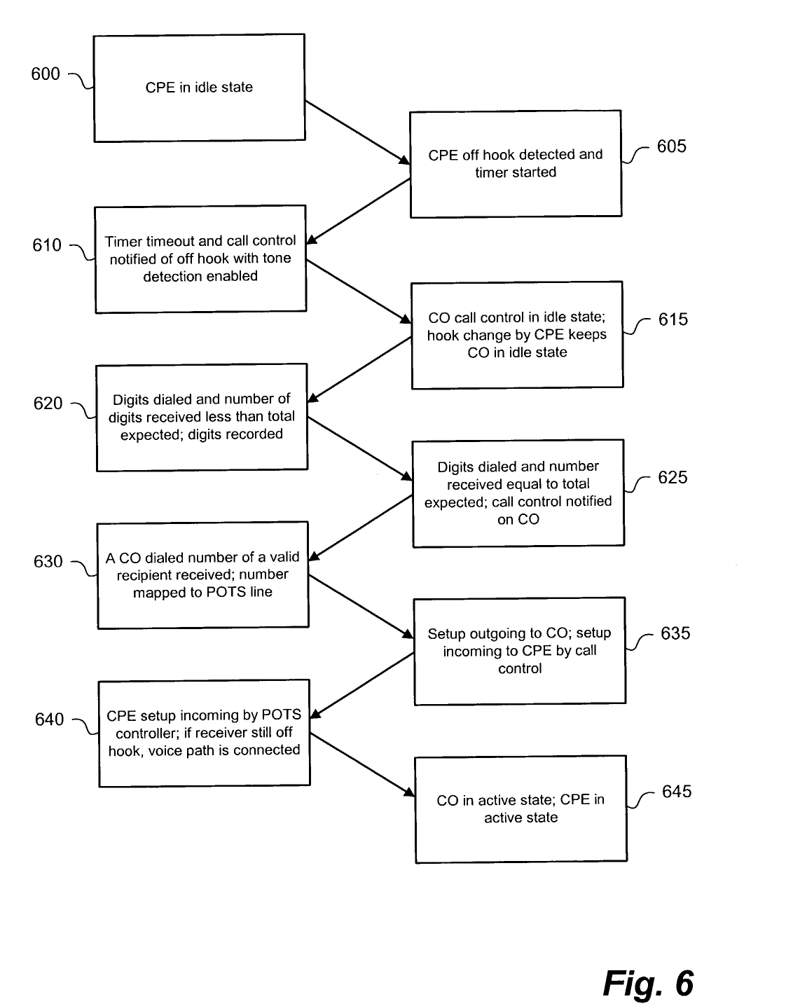

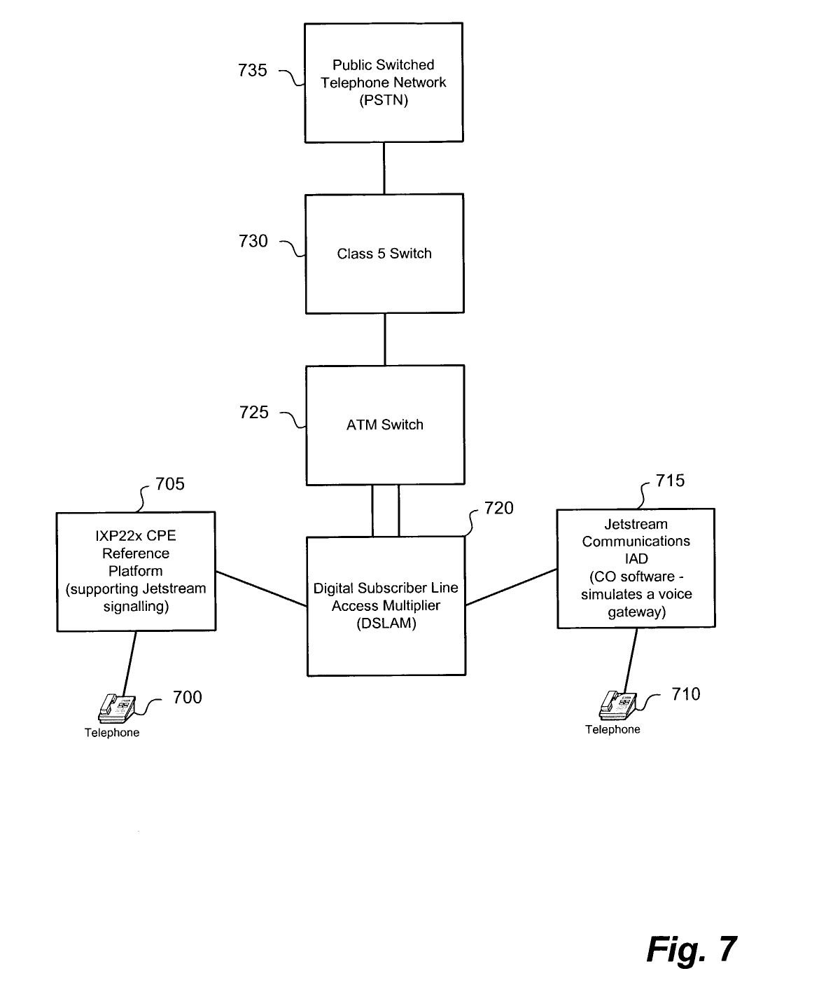

Referring to FIG. 6, a flow diagram of a voice call being activated between a CPE device and a CO device employing an embodiment of the present invention is shown. In block 600, the CPE POTS controller begins in Idle state from FIG. 4. Control is forwarded to block 605, where a CPE receiver connected to a CPE device is lifted off hook. The off hook is detected, which in turn, starts a timer. The timer represents the debounce time as set by the debounce logic. Control moves to block 610. With the timeout, the Call Control is notified of the off hook and tone detection is enabled. In block 615, the Call Control on the CO receives the off hook message. Nevertheless, the Call Control from FIG. 5 remains in Idle state awaiting a dialed number. In block 620, with the CPE POTS controller still in Idle state, digits are dialed from the CPE device. If the number of dialed digits received by the CPE device are less than the total expected, the digits are recorded by the POTS controller and remains in Idle state. In block 625, when enough digits are dialed, and the number received are equal to the total expected, control passes from the POTS CPE state machine to the Call Control state machine on the CO board. A message is sent of the dialed number from the CPE board to the CO board in block 630. The digits are matched up to the numbers in the CO directory. If the digits represent an invalid number, the Call Control state machine remains in Idle state. If the digits to the CO dialed number are matched with a valid recipient, the number is mapped to a POTS line. Control then passes to block 635, where the appropriate setup messages are sent to create the transfer of voice-band data for a call. These messages include all the information necessary to create a call, including but not limited to memory management and bandwidth resources control. An outgoing call to the CO is set up, and likewise an incoming call to the CPE by the Call Control state machine. Control is forwarded to block 640. In block 640, the CPE POTS controller in Idle state sets up an incoming call. If the receiver of the CPE device is still off hook, the voice path is connected. This moves both the CPE POTS state machine and CO Call Control state machine into active state in block 645, allowing voice traffic to pass between the two receivers.

Referring to FIG. 7, a block diagram showing an equipment setup required to utilize the IPX22x Voice over AAL2 application as known in the art. A telephone handset 700 is connected to the IXP22x CPE reference platform 705. The IXP22x is a set of Intel® Corporation's network processors. The IXP225 forms the core of the IXP22x reference platform for voice applications. A telephone handset 710 is connected to a Jetstream® Communcations' integrated access device (IAD). On board the IAD is Jetstream® developed software utilized by the CO to simulate a voice gateway. Both CPE and CO platforms require a connection through a digital subscriber line access multiplier (DSLAM) 720, and in turn out to the PSTN 735 via an ATM switch 725 and a Class 5 switch 730. The voice-band connection requires relatively expensive switches needed to run the PSTN network.

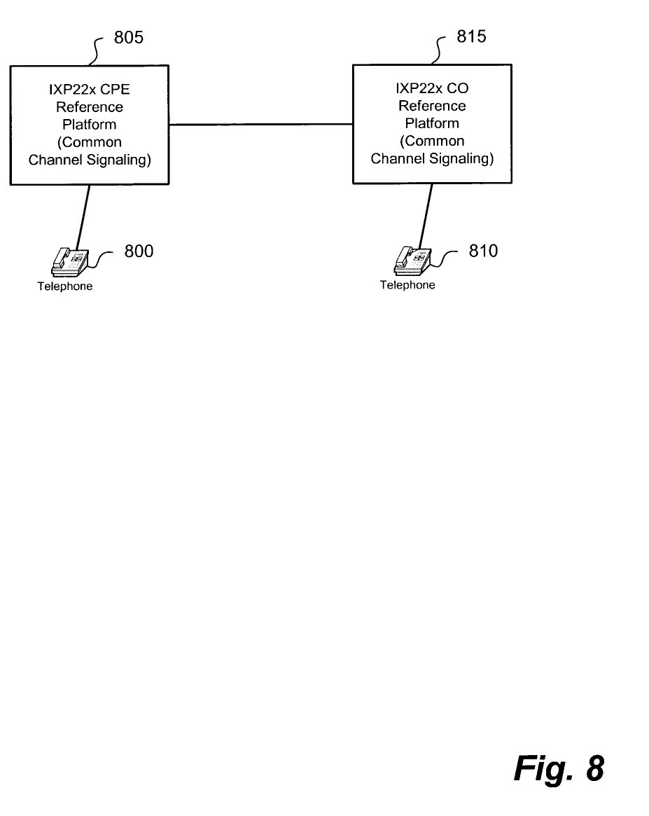

Referring to FIG. 8, a block diagram showing the equipment setup utilized for IPX22x Voice over AAL2 application when employing an embodiment of the present invention is shown. Utilizing two IXP22x reference platforms 805 and 815 as a CPE device and CO device, respectively, this embodiment of the present invention serves to partially emulate Class 5 switch signaling software. When connected to telephone handsets 800 and 810, a direct network connection between IXP22x CPE reference platform 805 and IXP22x CO reference platform 815 allows a voice call to be connected and voice-band data traffic to flow between the two. Reducing the equipment required to connect a voice path via VoAAL2 thereby significantly reduces cost for facilitating these calls. Although a single phone line is shown connected to the IXP22x reference platform, multiple phone line ports are supported on either end of the CPE or CO reference platforms.

The CCS method as described as an embodiment of the present invention, in part, provides a CO-side signaling stack which simulates a voice gateway within the CPE and CO devices. As seen in FIG. 8, it may do so without utilizing the equipment of FIG. 7, including DSLAM 720, ATM Switch 730 and Class 5 switch 730 or other voice gateway devices in order to terminate CPE-side signaling.

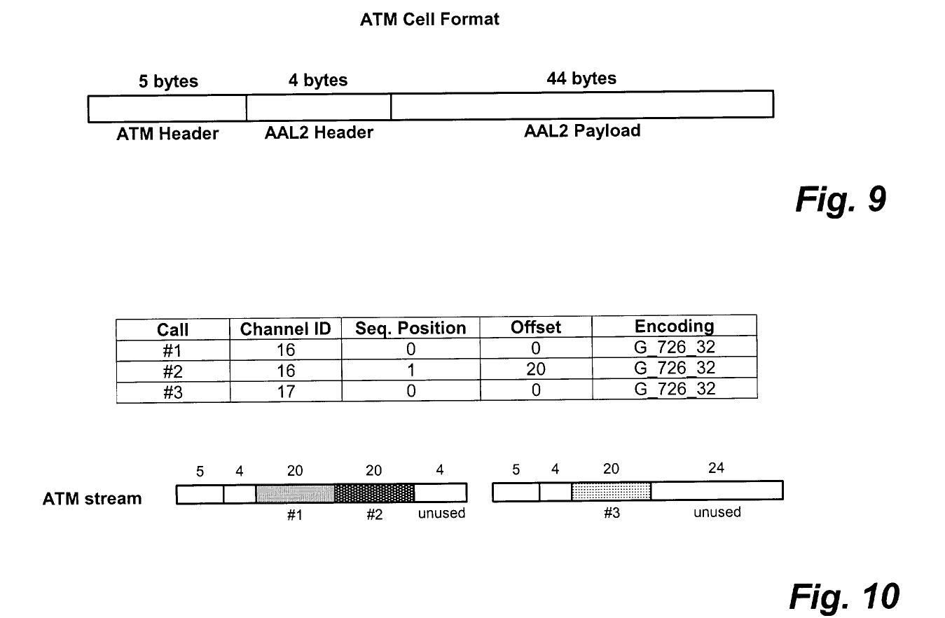

Referring to FIG. 9, a diagram of the ATM cell format of compressed voice samples of multiple POTS lines carried within one channel employing an embodiment of the present invention is shown. The first 5 bytes contains the ATM cell header and the next 4 bytes contain the AAL2 header. The remaining 44 bytes contain the AAL2 Payload—the voice-band information carried over AAL2. In an attempt to make optimal use of wide-area network (WAN) bandwidth at all times while supporting voice compression, the method described herein for an AAL2 channel (CID—Channel Identifier) re-mapping mechanism can be utilized. Each POTS device in an active state is assigned a CID and byte offset in the 44-byte payload. These are then individually selected to fit as many voice samples of POTS lines into one ATM cell payload without having to split any single sample across multiple cells.

Referring to FIG. 10, a diagram of an ATM stream with three sequential calls employing an embodiment of the present invention, and includes a table of the data reflected within these calls in the call control signaling stack is shown. This concept is demonstrated with three POTS lines using ITU G.726 compression @ 32K with a sampling rate of 5 milliseconds. The pattern of ATM cells to be transmitted is shown in FIG. 10. Having sequentially established three calls, the call control signaling stack would contain the data in the table also shown in FIG. 10. In this example employing an embodiment of the invention, two channels are used. Thus, every 5 milliseconds two ATM cells are required to carry all the voice data. This implies a cell rate of 400 cells per second, consuming approximately 170 Kbps of bandwidth.

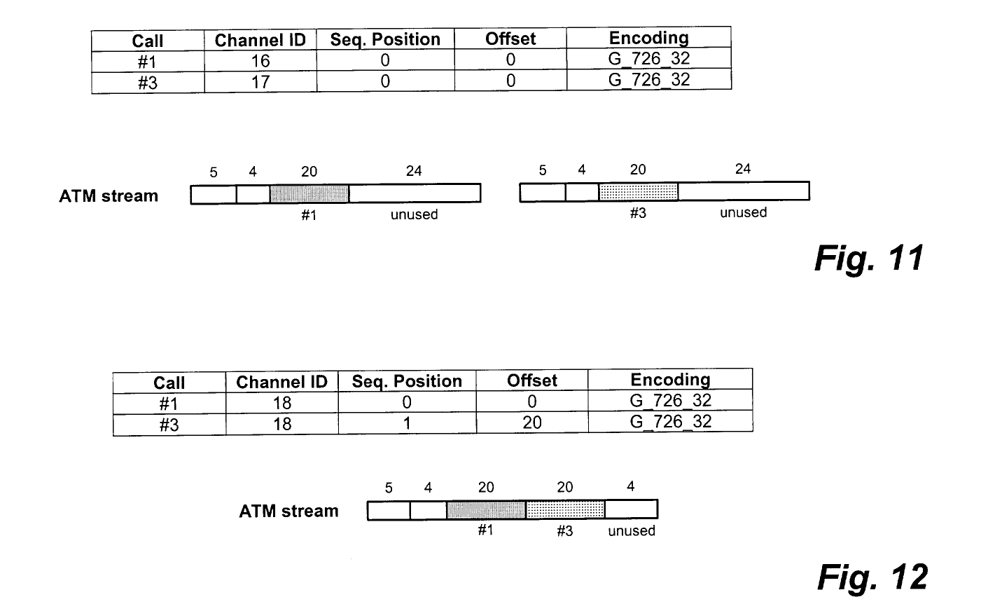

Referring to FIG. 11, a diagram of an ATM stream with the second call of three sequential calls dropped without utilizing an embodiment of the present invention, and includes a table of the data reflected within these calls in the call control signaling stack is shown. If call #2 is terminated, the configuration for the ATM stream without channel re-mapping is shown in FIG. 3. Two channels are still used, with a 24-byte block within each ATM cell wasted. Therefore, the same line bandwidth is still consumed as that of the three calls as seen in FIG. 10. Also shown in the table in FIG. 11 is the data from the call control signaling stack from the two remaining calls without CID re-mapping.

Referring to FIG. 12, a diagram of an ATM stream with the second call of three sequential calls dropped employing an embodiment of the present invention, and includes a table of the data reflected within these calls in the call control signaling stack is shown. In FIG. 12, with channel re-mapping, if call #2 is dropped, the configuration for the ATM stream is shown with the two remaining calls re-mapped to a single channel. The data from the call control signaling stack is also shown in a table in FIG. 12. With channel re-mapping, optimal WAN bandwidth is achieved by reconfiguring the remaining active calls of the channel associated with the terminated call. The two calls now occupy only one channel and only one ATM cell. The cell rate is reduced to 200 cells per second, and as a result, consumes approximately 85 Kbps. This example of one embodiment of the present invention demonstrate the effectiveness of the channel re-mapping method for optimal bandwidth utilization.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

What is claimed is:

1. A network telephony system comprising:
a first networked device, which is to be coupled to a second networked device via a wide-area connection, said first networked device to send and receive signaling messages and re-mapped voice samples transported over a single common asynchronous transfer mode adaptation layer channel.

2. The system of claim 1 wherein said first networked device is equipped with a call control module and a POTS control module coupled to a first telephonic device.

3. The system of claim 2 wherein said second networked device is equipped with a call control module and a POTS control module coupled to a second telephonic device.

4. The system of claim 3 wherein said first networked device is a customer premise equipment device and said second networked device is a central office device.

5. The system of claim 3 wherein said second networked device is a central office device and said second networked device is a customer premise equipment device.

6. The system of claim 3 wherein said asynchronous transfer mode adaptation layer is ATM Adaptation Layer Type 2 supporting voice compression.

7. The system of claim 6 wherein said call control module is operable to re-map a maximum number of voice samples into each asynchronous transfer mode cell.

8. The system of claim 7 wherein said call control module is operable to reconfigure a maximum number of active calls into a single common asynchronous transfer mode adaptation layer channel.

9. The system of claim 8 wherein said message signaling is exchanged by common channel signaling.

10. The system of claim 6 wherein said call control module is operable to send and receive said signaling messages to and from said POTS modules coupled to said first telephonic device and second telephonic device.

11. The system of claim 10 wherein said POTS modules coupled to said first telephonic device and second telephonic device are operable to send and receive said signaling messages to and from said call control module.

12. The system of claim 11 wherein said signaling messages are comprised of:
call setup messages;
call release messages; and
notification messages.

13. The system of claim 12 wherein said message signaling is exchanged by common channel signaling.

14. The system of claim 6 wherein said POTS modules coupled to said first telephonic device and second telephonic device are operable to detect user actions from said first telephonic device and second telephonic device

15. The system of claim 14 wherein said user actions are comprised of:
hook changes; and
dialed digits.

16. The system of claim 6 wherein POTS modules coupled to said first telephonic device and second telephonic device are operable to monitor the analog line states said first and second telephonic devices.

17. The system of claim 16 wherein said analog line states are on hook or off hook.

18. The system of claim 17 wherein said analog line states are exchanged between said first networked device and said second networked device

19. The system of claim 18 wherein said analog line states are stored in at least two bits of each asynchronous transfer mode adaptation layer header.

20. The system of claim 19 wherein said asynchronous transfer mode adaptation layer header is exchanged by channel associated signaling.

21. In a network telephony system including at least two networked devices connected via a wide-area network, a method for enabling voice telephony transported over a single common asynchronous transfer mode adaptation layer channel, comprising:
detecting an off hook of a first networked device on a first POTS controller module;
enabling tone detection on said first POTS controller module;
detecting a set of dialed digits for a second networked device by said first POTS controller module;
notifying said call control module of said set of dialed digits;
mapping the set of dialed digits to a POTS line by said call control module;
sending setup messages to said first POTS controller module and to a second POTS controller module;
activating a voice call between said first networked device and said second networked device; and
reconfiguring a maximum number of active voice calls into a single common asynchronous transfer mode adaptation layer channel.

22. The system of claim 21 further comprising:
detecting an on hook on one of said networked devices; and
releasing said voice call between said first networked device and said second networked device.

23. The system of claim 22 wherein detecting an off hook further comprises initiating a timer set by a debounce logic.

24. The system of claim 23 wherein detecting a set of dialed digits further comprises recording said set of dialed digits if said set of dialed digits is less than total digits expected.

25. The system of claim 24 wherein activating a voice call further comprises connecting a voice path over a single common asynchronous transfer mode adaptation layer channel

26. A set of instructions residing in a storage medium, said set of instructions capable of being executed by a processor to implement a method for enabling voice telephony between a first networked device and second networked device, comprising:
detecting an off hook of a first networked device on a first POTS controller module;
enabling tone detection on said first POTS controller module;
detecting a set of dialed digits for a second networked device by said first POTS controller module;
notifying said call control module of said set of dialed digits;
mapping the set of dialed digits to a POTS line by said call control module;
sending setup messages to said first POTS controller module and to a second POTS controller module;
activating a voice call between said first networked device and said second networked device; and
reconfiguring a maximum number of active voice calls into a single common asynchronous transfer mode adaptation layer channel.

27. The set of instructions of claim 26 further comprising:
detecting an on hook on one of said networked devices; and
releasing said voice call between said first networked device and said second networked device.

28. The set of instructions of claim 27 wherein detecting an off hook further comprises initiating a timer set by a debounce logic.

29. The set of instructions of claim 28 wherein detecting a set of dialed digits further comprises recording said set of dialed digits if said set of dialed digits is less than total digits expected.

30. The set of instructions of claim 29 wherein activating a voice call further comprises connecting a voice path over a single common asynchronous transfer mode adaptation layer channel
